(19) United States
(12) Patent Application Publication
(10) Pub. No.: US 2007/0285328 A1
(43) Pub. Date: Dec. 13, 2007

(54) Slot Antenna for Television Reception

(75) Inventor: Alfredo Mariola, Anzio (IT)

Correspondence Address: SIMPSON & SIMPSON, PLLC, 5555 MAIN STREET, WILLIAMSVILLE, NY, 14221-5406, US

(73) Assignee: M.C. ELETTRONICA DI MARIOLA ALFREDO, Nettuno (IT)

(21) Appl. No.: 11/579,076

(22) PCT Filed: Apr. 28, 2005
(86) PCT No.: PCT/EP05/51920

§ 371 Date: Oct. 30, 2006

(30) Foreign Application Priority Data
Apr. 30, 2004 (IT) RM2004A000211

(51) Int. Cl. H01Q 13/10

(52) U.S. Cl. 343/767

(57) ABSTRACT

Aluminium slot antenna for receiving radio signals, in particular in the VHF and UHF bands, consisting of two flat and elongated bars fastened parallel to one another by cross-pieces that form electrical bridges. There is a connecting element for a coaxial electrical power supply cable arranged in a predetermined position between the center of the slot and one end thereof and there are fastening means to keep the antenna in a vertical position.

### FIELD OF THE INVENTION

This invention relates to a slot antenna for receiving radio frequency signals used in particular for television broadcasting.

### BACKGROUND ART

At domestic level, antennas for receiving signals in the VHF and UHF bands, for example for receiving radio and television signals, are usually of the Yagi type. These types of antennas, which are widely used throughout the world to receive signals transmitted by terrestrial repeaters, are of simple construction and relatively low-cost, which accounts for their widespread use.

However, these antennas are associated with a plurality of drawbacks. They are directional antennas and must therefore be installed in the correct position, which involves lengthy installation times and the use of additional accessories. Furthermore, if the user wishes to receive television signals from terrestrial stations that are angularly distant from each other, the quality of the signal broadcast by the transmitting station with which the Yagi antenna is not aligned is very poor. In order to receive television programmes broadcast by different transmitting stations, several Yagi antennas must therefore be installed on the same supporting mount. This results in increased installation costs and leads to the proliferation of so-called jungles of antennas on the roofs of large apartment blocks. This effect is not attractive.

Due to their limited cost, Yagi antennas are also used on vehicles and ships. However, the fact that these are highly directive antennas represents a significant drawback when the vehicle or ship is moving.

Other types of antennas have been developed for domestic use to receive television programs, but these solutions are more expensive than Yagi antennas and they are not very widely used.

Slot antennas have been used for television broadcasting, mainly for the transmission of signals. An example of one such antenna is described in patent U.S. Pat. No. 4,851,857. This document refers to a cylindrical high-power UHF TV antenna that can be used in a vertical position with a plurality of diametrically opposed slots arranged along the length of the cylinder.

However, this type of antenna has some drawbacks, mainly in terms of the costs involved, that make widespread use at domestic level improbable.

### SUMMARY OF THE INVENTION

One purpose of this invention is to provide an antenna for receiving television or radio signals, in particular in the UHF and VHF bands, that is very cheap to produce and has an almost omnidirectional reception pattern, but with a very compact structure and overall dimensions.

These purposes are achieved, according to this invention, with an antenna having the characteristics according to claim 1.

Thanks to the characteristics of the antenna, the structure is very simple in its construction and very compact. An aerodynamic fairing can be installed to improve the general appearance of the antenna and also to minimize the aerodynamic forces produced by the wind or by movements of the antenna that affect the latter. Furthermore, thanks to its ease of construction, extremely low unit production costs can be achieved.

Signal reception is particularly good, in that it is almost omnidirectional. This makes the antenna suitable for use even in case of signals transmitted by transmitting stations that are angularly distant from each other, or on moving vehicles.

### LIST OF DRAWINGS

Further advantages of this invention will become clear from the following detailed description of a preferred, but not limitative, embodiment of the antenna with reference to the following drawings, of which:

FIG. 1 is a block diagram of the antenna according to the invention in the context of use for the reception of radio and television signals;

FIG. 2 is a perspective view of an antenna according to the invention;

FIG. 3 is a view of a detail of an antenna in FIG. 2;

FIG. 4 is an enlarged view of two details of the antenna in FIG. 2;

FIG. 5 is the radiation pattern of the antenna according to the invention.

### DETAILED DESCRIPTION OF A PREFERRED EMBODIMENT

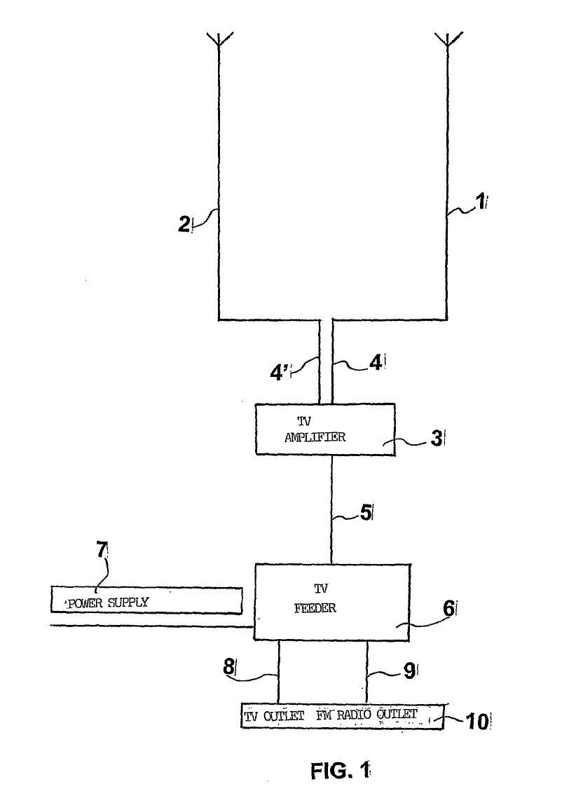

FIG. 1 illustrates a block diagram of a normal radio-television signal receiving station. The UHF receiving antenna 1 and the VHF receiving antenna 2 of the invention are connected by means of the cables 4, 4′ to an amplifier 3, that amplifies the signal received by the antennas and transmits it to the output via an F connector and via the cable 5 to a TV signal feeder 6. The length of the supply cables 4, 4′ is dimensioned so that the two sections are in phase. The signal feeder 6 is powered by means of a conventional electrical power supply 7. The output signal from the signal feed 6 is transmitted via the two cables 8 and 9 to a TV outlet and to a radio outlet 10. The television set and/or radio can in turn be connected to the TV and FM radio outlets 10.

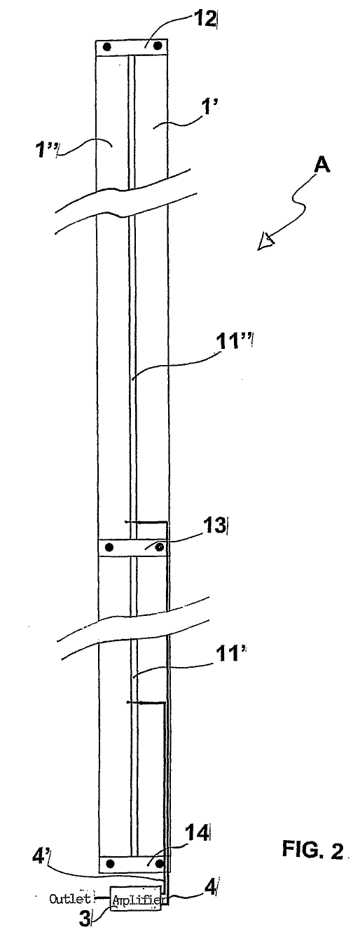

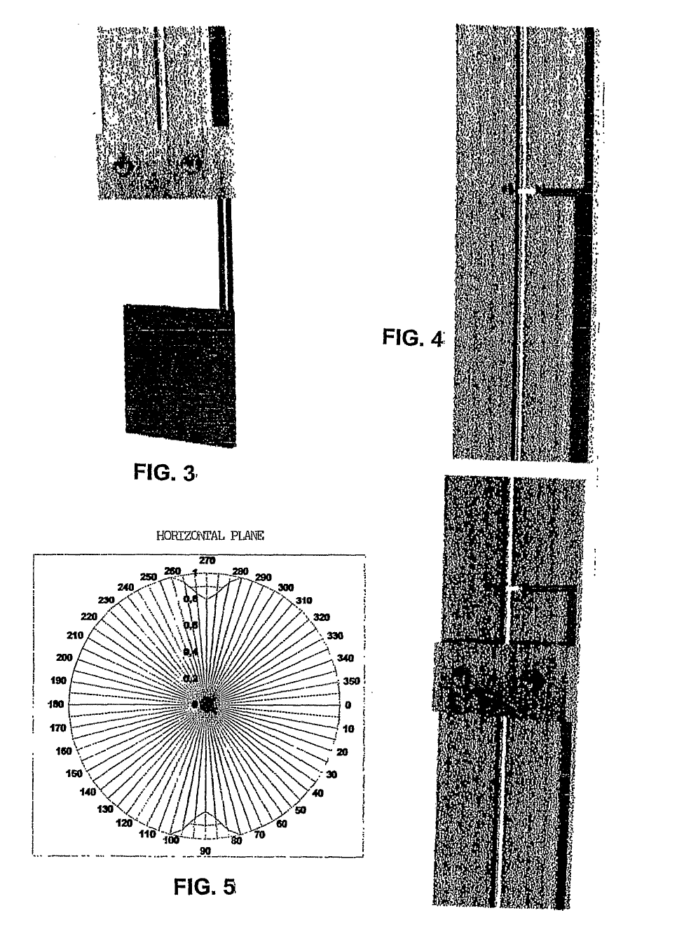

The structure of the antenna is illustrated in greater detail in FIGS. 2 to 4. The antenna, globally referenced by the letter A, consists of two metal lines 1′, 1″ of a suitable length arranged parallel to each other so as to form a longitudinal slot 11′, 11″ of a predetermined width. The two metal lines 1′, 1″ are permanently jointed, for example by means of riveting, welding or another suitable method depending on the type of metal that is used, by a plurality of straps 12, 13, 14. In this preferred embodiment of the invention there are three straps as this antenna is suitable for receiving three bands: UHF, VHF and FM radio, but fewer or more straps may be used, depending on the type of antenna that is required, or the number of bands that the antenna needs to receive. An antenna with a single slot that is delimited by two straps at the ends can only receive one band, which may be the UHF or VHF band, depending on the length of the antenna.

Power is supplied to the VHF-receiving part of the antenna by means of a suitable cable 4, for example by means of a 50 Ohm cable, welded to the lower part of the antenna approximately 30 mm from the end of the slot 11″.

Power is supplied to the UHF-receiving part of the antenna by means of a suitable cable 4′, for example by means of a 50 Ohm cable, welded to the central part of the slot 11′. The antenna thus implemented is a collinear antenna with horizontal polarization.

In an alternative embodiment, the antenna may consist of a single element of which the central part is cut out to create the slot or slots 11′, 11″ of a suitable size. In a first alternative embodiment of the antenna the slots are aligned along the same axis; in a second alternative embodiment the slots are not aligned. The latter solution enables a reduction of loss on points at which gain is reduced.

The antenna is made of aluminium, which is a low-cost material, but other conductive materials may be used.

Good reception of television and radio signals in the UHF, VHF and FM radio bands is achieved with an antenna that is approximately 1220 mm in length, with the two slots 440 mm and 750 mm long and each 3 mm wide, and with the metal lines 1′, 1″ 30 mm wide.

An example of a model of the antenna according to the invention has the characteristics shown in the following table:

| | |
|---|---|
| Type | TV antenna |
| Frequency spacing | 80-110 180-250 480-1000 MHz |
| Gain | VHF 4.5 dBi UHF 6 dBi |
| Amplifier gain | 70-1000 MHz 26 dB |
| Impedance | 75 Ohm |
| Polarization | Horizontal |
| Vertical plane (−3 dB) | VHF 62° UHF 42° |
| Radiation pattern | Omnidirectional |
| Connector | F Female |
| Weight | 1.1 Kg |
| Maximum dimensions | 1500 mm × 50 mm |

The directional characteristics of the antenna according to this invention, which has a perfectly horizontal polarization and an omnidirectional radiation pattern covering almost 95% of the circumference, meaning that wherever the antenna is placed there is an area of around 5% in which the signal is slightly weaker, make it suitable for use on vehicles and ships even when moving. Furthermore, there is no need for the use of more or less complex tools to orientate the antenna. From the diagram in FIG. 5 the person skilled in the art will observe the almost perfect omnidirectional radiation pattern of the antenna. The diagram clearly shows a gain reduction of approximately 2 dB in terms of circularity.

Thanks to its compact structure and to its extremely limited height and weight, the antenna is easy to install and is not conspicuous on the building or vehicle. A fairing made of a suitable material, such as glass reinforced plastic, may be placed around the antenna to protect the structure and give it an aerodynamic profile capable of withstanding hurricane-force winds. The antenna according to the invention has been tested with wind-speeds of up to 200 km/h.

The antenna can also be appropriately dimensioned so that it is suitable for receiving radio signals in other bands.

1. Antenna for receiving radio signals in the VHF and/or UHF bands, comprising a flat and elongated metal member, with at least one through slot, arranged lengthwise, wherein there is a connecting element for a coaxial electrical power supply cable arranged in a predetermined position between the center of the slot and one end thereof, and wherein the metal member incorporates fastening means for fixing the antenna to supporting means.

2. Antenna according to claim 1, wherein the flat metal member has two axially aligned slots (11′, 11″) separated by a solid metal area.

3. Antenna according to claim 1, wherein the flat metal member has two slots (11′, 11″) not aligned axially and separated by a solid metal area.

4. Antenna according to claims 1 to 3, wherein the metal member comprises two elongated bars (1′, 1″) joined, at predetermined places along the length thereof, by metal cross-pieces that form electrical bridges.

5. Antenna according to claim 4, wherein there are provided three metal cross-pieces (12, 13, 14).
